(19) United States
(12) Patent Application Publication
(10) Pub. No.: US 2010/0313091 A1
(43) Pub. Date: Dec. 9, 2010

(54) APPARATUS AND METHOD FOR TESTING SEMICONDUCTOR INTEGRATED CIRCUIT

(75) Inventor: Yoshiaki Kodashiro, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/794,183

(22) Filed: Jun. 4, 2010

(30) Foreign Application Priority Data
Jun. 8, 2009 (JP) 2009-137583

(51) Int. Cl. G06F 11/00

(52) U.S. Cl. 714/735; 714/736; 714/E11.02

(57) ABSTRACT

A plurality of tester channels is provided. The tester channels are capable of outputting double speed test patterns when a pin-multiplex-mode is designated. Each of the tester channels is provided with a level determination unit to output a level determination signal, a signal multiplexing unit, and an expected value comparison unit to receive an output from the signal multiplexing unit. The signal multiplexing unit multiplexes an outputted level determination signal obtained in one of the tester channels and a level determination signal obtained from a level determination unit of another one of the tester channels when a double speed test mode is designated. The signal multiplexing unit outputs a signal corresponding to the level determination signal of the one of the tester channels when the double speed test mode is canceled. A strobe time can be set individually for each of the tester channels to obtain a comparison result.

### CROSS REFERENCE TO RELATED APPLICATION

The application is based upon and claims the benefit of priority from the prior Japanese Patent Application No. 2009-137583, filed on Jun. 8, 2009, the entire contents of which are incorporated herein by reference.

### FIELD

The invention relates to an apparatus and method to perform a double speed test for a semiconductor integrated circuit.

### DESCRIPTION OF THE BACKGROUND

For the purpose of examining functions of a semiconductor integrated circuit, test apparatuses are used widely. In recent years, a double speed test has been frequently performed using a pin-multiplex-mode so as to meet speed-up operation of a semiconductor integrated circuit.

Under a pin-multiplex-mode, two tester channels are used to generate a test signal waveform to be provided to each pin of a semiconductor integrated circuit. The test signal waveform has twice an operation frequency of a test apparatus and is produced by alternating waveforms of two test signals generated in the respective tester channels every half a cycle of the signals.

Accordingly, if a pin-multiplex-mode is applied simply, two tester channels are necessary for each pin of a semiconductor integrated circuit to be tested. As a result, the number of usable tester channels decreases. This causes decrease of the number of semiconductor integrated circuits which can be tested simultaneously.

Japanese Patent Application Publication No. 11-232899 (page 3, FIG. 1) discloses an improved testing method using two tester channels. According to the testing method, a test signal from one of the two tester channels is inputted into the other of the tester channels. A test signal from the other of the tester channels is inputted into the one of the tester channels. In the tester channels, similar test signal waveforms are generated to carry out a double speed mode respectively. The test signal waveforms are respectively inputted into two separate semiconductor integrated circuits to be tested which are electrically connected to the tester channels. This allows increasing the number of semiconductor integrated circuits to be tested simultaneously.

Further, Japanese Patent Application Publication No. 2000-163989 (page 4, FIG. 2) proposes a method of verifying an output waveform of a double speed mode outputted from a semiconductor integrated circuit to be tested when a test signal of a double speed waveform is inputted into the semiconductor integrated circuit.

For the verification, two tester channels are used to test one unit of semiconductor integrated circuit. The tester channels are provided with comparators. An output waveform obtained from the semiconductor integrated circuit is inputted into the comparators simultaneously. The inputted waveform is logically compared with an expected value of a double speed mode in each comparator. The comparison is performed at different timings.

The proposed verification method allows testing a signal outputted from a semiconductor integrated circuit under a double speed mode. However, the method causes decrease of the number of semiconductor integrated circuits to be tested simultaneously. It is because, in the verification method, two tester channels are necessary for each output pin of a semiconductor integrated circuit.

### BRIEF DESCRIPTION OF THE DRAWINGS

FIG. 1 is a block diagram showing a configuration of a tester channel arranged in a test apparatus according to an embodiment of the invention.

FIG. 2 is an explanatory view of an operation of a level determination unit which constitutes the tester channel of the embodiment.

FIG. 3 shows an electrical connection example between semiconductor integrated circuits to be tested and tester channels to test output signals from the semiconductor integrated circuits simultaneously in a double speed mode.

FIG. 4 is a flow chart to show a method to test output signals from semiconductor integrated circuits simultaneously in a double speed mode, using the test apparatus of the embodiment.

FIG. 5 shows wave forms to show an operational example of the test apparatus which is obtained when a test is performed in a double speed mode according to the method shown in FIG. 4.

FIG. 6 is wave forms to show an operational example which causes a difference between an inputted signal and an expected value when a test is performed in a double speed mode according to the method shown in FIG. 4.

FIG. 7 is a flow chart to show a testing method to be performed in the case where the difference is caused.

FIG. 8 shows wave forms to demonstrate an operational example of the test apparatus in the case where a double speed mode is cancelled according to the method shown in FIG. 7.

### DETAILED DESCRIPTION

In one embodiment, an apparatus for testing a semiconductor integrated circuit is provided. The apparatus includes plural tester channels. Each of the tester channels is capable of outputting a double speed test pattern when a pin-multiplex-mode is designated. Each of the tester channels is provided with a level determination unit, a signal multiplexing unit and an expected value comparison unit.

The level determination unit is configured to determine whether an inputted signal level fulfills a predetermined value and to output a level determination signal. The signal multiplexing unit is configured to multiplex the outputted level determination signal and a level determination signal obtained from a level determination unit of another one of the tester channels when a double speed test mode is designated. The signal multiplexing unit is configured to output a signal corresponding to the level determination signal outputted from the level determination unit of each of the tester channels when the double speed test mode is canceled. The expected value comparison unit is configured to compare the output of the signal multiplexing unit with an expected value and to output a comparison result. A strobe time can be set individually for each of the tester channels to obtain the comparison result.

In another embodiment, an apparatus for testing a semiconductor integrated circuit is provided. The apparatus includes first and second tester channels. Each of the first and the second tester channels is capable of outputting a double speed test pattern when a pin-multiplex-mode is designated. The first tester channel is provided with a first level determination unit, a first signal multiplexing unit and a first expected value comparison unit. The second tester channel is provided with a second level determination unit, a second signal multiplexing unit and a second expected value comparison unit. The first and the second level determination unit are configured to determine whether an inputted signal level fulfills a predetermined value and to output first and second level determination signals, respectively. The first and the second multiplexing unit are configured to multiplex the outputted first and second level determination signals and the second and first level determination signals obtained from the second and the first level determination units respectively when a double speed test mode is designated, and to output signals corresponding to the first and second level determination signals outputted from the first and second level determination units respectively when the double speed test mode is canceled. The first and the second expected value comparison units are configured to compare the outputs of the first and the second signal multiplexing units with expected values and to output comparison results respectively. Different strobe times can be set for the respective first and second tester channels to obtain the comparison results.

In further another embodiment, a method is provided to test a semiconductor integrated circuit in accordance with designation of a pin-multiplex-mode. According to the method, double speed test patterns are inputted into first and second semiconductor integrated circuits to be tested respectively. First and second output signals outputted from the first and second semiconductor integrated circuits are inputted into first and second tester channels respectively. Signal levels of the first and second output signals are determined in the first and second tester channels. First and second level determination results are inputted into the second and first tester channels. A double speed test mode is designated for the first and second tester channels. A strobe time of the first tester channel is set in a first half of a test cycle. A strobe time of the second tester channel is set in a second half of the test cycle. Signals corresponding to the first and second level determination results are compared with expected values by the first and second tester channels respectively.

Hereinafter, a further embodiment will be described with reference to the drawings. The same numerals designate the same or similar portions respectively.

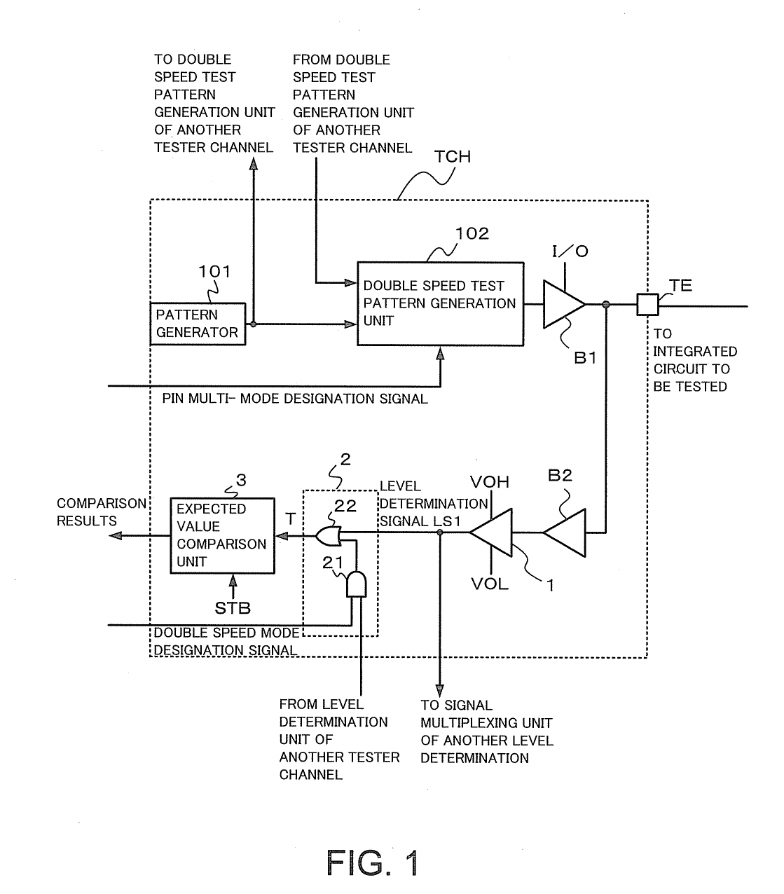

FIG. 1 is a block diagram showing a configuration example of a tester channel arranged in a test apparatus according to the further embodiment.

As shown in FIG. 1, the test apparatus has a tester channel TCH. The tester channel TCH is provided with a pattern generator 101, a double speed test pattern generation unit 102 and a three state output buffer B1. Further, the tester channel TCH is provided with an input buffer B2, a level determination unit 1, a signal multiplexing unit 2, an expected value comparison unit 3 and a terminal TE.

The terminal TE is arranged to connect with a semiconductor integrated circuit to be tested (not shown). An output signal obtained from the terminal TE of the semiconductor integrated circuit is inputted into the input buffer B2.

The double speed test pattern generation unit 102 receives an output of the pattern generator 101 and an output of a pattern generator of another tester channel (not shown) provided in the test apparatus. The double speed test pattern generation unit 102 generates a double speed test pattern.

The output state of the three state output buffer B1 is set up by an input and output switching signal I/O. The double speed test pattern generation unit 102 can output a double speed test pattern via the three state output buffer B1 when a pin-multiplex-mode is designated by a pin multi-designation signal.

The level determination unit 1 determines whether the signal level of the output signal from the semiconductor integrated circuit, which is inputted via the input buffer B2, fulfills a predetermined value. The level determination unit 1 outputs a level determination signal LS1 which shows a determination result.

The signal multiplexing unit 2 multiplexes the level determination signal LS1 and a level determination signal from another test channel and outputs a multiplexed signal, when a double speed test mode is designated by a double speed mode designation signal. The signal multiplexing unit 2 outputs the level determination signal LS1 outputted from the level determination unit 1 only, when the double speed test mode is canceled.

The designation and cancellation of the double speed test mode can be controlled independently from the output of the double speed test pattern.

The expected value comparison unit 3 compares an output signal T from the signal multiplexing unit 2 with predetermined high and low expected values 3H and 3L of high level and low level sides respectively, at the time set up by an designation signal STB which shows a strobe time. The ‘high level’ will be referred to as “‘H’ level”, hereinafter. The ‘Low level’ will be referred to as “‘L’ level”, hereinafter.

In FIG. 1, the level determination unit 1, the signal multiplexing unit 2 and the expected value comparison unit 3 is expressed as one unit respectively for simplification. Actually, as is described below, two level determination units, two signal multiplexing units and two expected value comparison units are employed in order to perform processing for ‘H’ level and ‘L’ level signals.

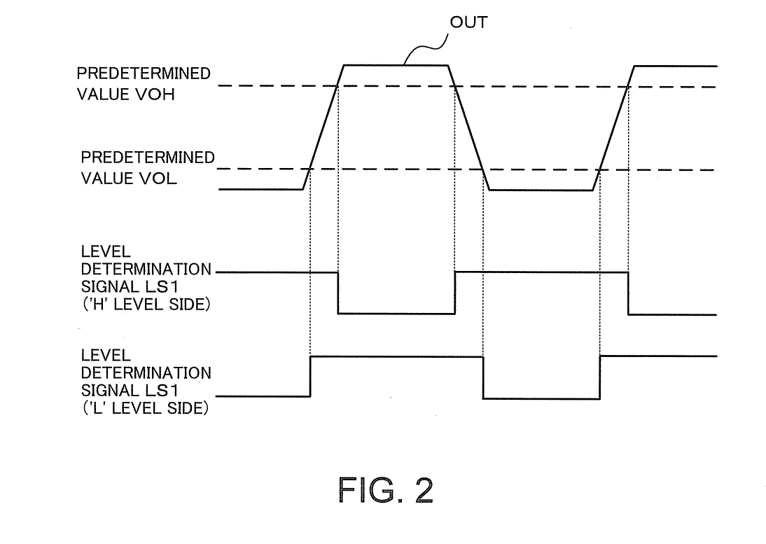

An operation of the level determination unit 1 shown in FIG. 1 will be explained with reference to FIG. 2.

The level determination unit 1 compares the output signal of the semiconductor integrated circuit denoted as “OUT” in FIG. 2 with a predetermined ‘H’ level value VOH and a predetermined ‘L’ level value VOL. The level determination unit 1 outputs level determination signals of the ‘H’ level and ‘L’ level sides as the determination signal LS1, as will be described in detail below.

The level determination unit 1 outputs a signal of ‘L’ level as the level determination signal of the ‘H’ or ‘L’ level side, when the output signal of the semiconductor integrated circuit fulfills the predetermined ‘H’ or ‘L’ level value, respectively.

Further, the level determination unit 1 outputs a signal of ‘H’ level as the level determination signal of the ‘H’ or ‘L’ level side, when the output signal of the semiconductor integrated circuit does not fulfill the predetermined ‘H’ or ‘L’ level value, respectively.

In FIG. 1, the level determination signals of the ‘H’ and ‘L’ level sides are denoted as the level determination signal LS1 in common.

The signal multiplexing unit 2 is provided with an AND gate 21 and an OR gate 22. The AND gate 21 receives a double speed mode designation signal and the output signal from the level determination unit of the other tester channel (not shown). The OR gate 22 receives an output from the AND gate 21 and the level determination signal LS1 outputted from the level determination unit 1.

A double speed test mode is designated when the double speed mode designation signal is ‘1’. The output T of the signal multiplexing unit 2 is an output from the OR gate 22 under the double speed test mode.

Thus, the output T of the signal multiplexing unit 2 becomes ‘H’ level, if the level determination unit 1 outputs a signal of ‘H’ level indicating that the output signal of the semiconductor integrated circuit does not fulfill the predetermined ‘H’ or ‘L’ level value, as the level determination signal LS1.

On the other hand, the double speed test mode is canceled when the double speed mode designation signal becomes ‘0’. In this case, the OR gate 22 is prevented to receive the level determination signal of the other tester channel by the AND gate 21. Thus, the output T of the signal multiplexing unit 2 becomes the level determination signal LS1 itself outputted from the level determination unit 1.

Two output signals of the ‘H’ and ‘L’ level sides are outputted from the signal multiplexing unit 2, but the output signal T is denoted in common in FIG. 1.

The expected value comparison unit 3 compares the output T of the signal multiplexing unit 2 with a predetermined expected value. Specifically, the expected value comparison unit 3 compares the expected value H with the output of the ‘H’ level side obtained from the signal multiplexing unit 2. Further, the expected value comparison unit 3 compares the expected value L with the output of the ‘L’ level side obtained from the signal multiplexing unit 2.

In the embodiment, the strobe time for the expected value comparison unit can be set by a designation signal STB in each tester channels.

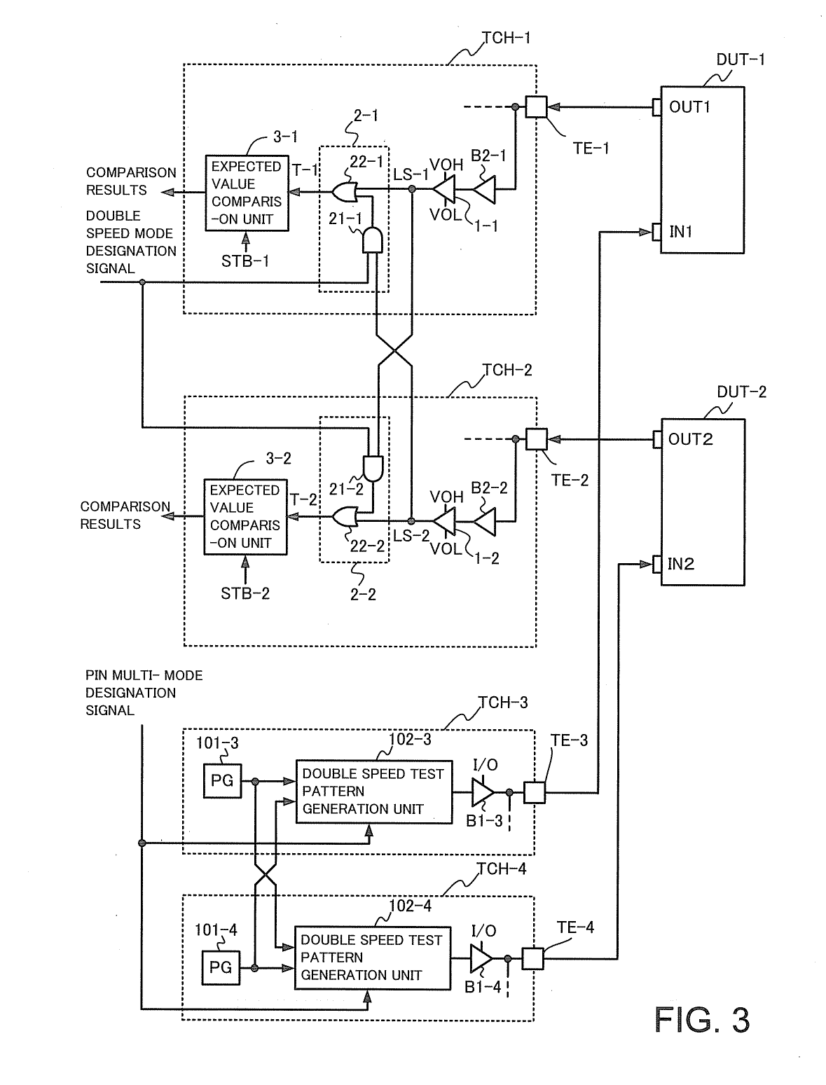

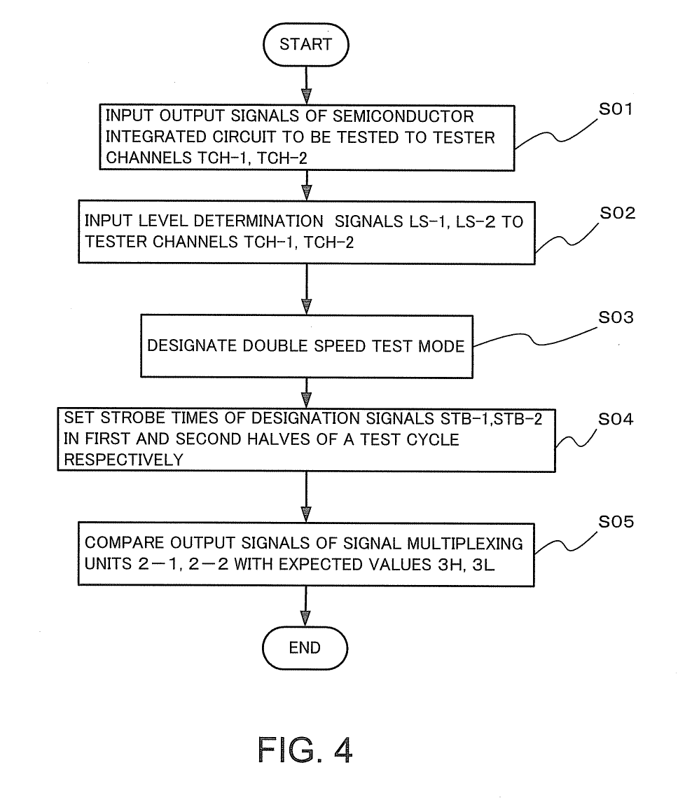

A method for testing output signals from plural semiconductor integrated circuits to be tested will be explained with reference to FIGS. 3, 4. The test is performed simultaneously at a double speed by using the tester channels of the test apparatus of the above embodiment. FIG. 3 shows an electrical connection between the semiconductor integrated circuits and the tester channels which is used to test the output signals. FIG. 4 is a flow chart showing the test method.

In FIG. 3, tester channels TCH-1, TCH-2 are provided with input buffers B2-1, B2-2, level determination units 1-1, 1-2, signal multiplexing units 2-1, 2-2 and expected value comparison units 3-1, 3-2, respectively. The signal multiplexing units 2-1, 2-2 are provided with AND gates 21-1, 21-2 and OR gates 22-1, 22-2, respectively. In FIG. 3, each of the level determination units 1-1, 1-2, the signal multiplexing units 2-1, 2-2 and the expected value comparison units 3-1, 3-2 is expressed as one unit for simplification. Actually, as is described below, two determination units, two signal multiplexing units and two expected value comparison units are employed in each of the tester channels TCH-1, TCH-2, in order to perform processing for ‘H’ level and ‘L’ level signals.

Further, each of the tester channels TCH-1, TCH-2 is provided with a pattern generator, a double speed test pattern generation unit and a three state output buffer, similarly to the tester channel shown in FIG. 1.

In FIG. 3, tester channels TCH-3 and TCH-4 are provided with pattern generator 101-3, 101-4, double speed test pattern generation unit 102-3, 102-4, and three state output buffer B1-3, B1-4, respectively.

Each of the tester channels TCH-3, TCH-4 is provided with an input buffer, a level determination unit, a signal multiplexing unit and an expected value comparison unit, similarly to the tester channel shown in FIG. 1. Actually, two determination units, two signal multiplexing units and two expected value comparison units are employed in each of the tester channels TCH-3, TCH-4, in order to perform processing for ‘H’ level and ‘L’ level signals.

The electrical connection shown in FIG. 3 aims to test two output signals from semiconductor integrated circuits DUT-1, DUT-2 simultaneously at a double speed using the tester channels TCH-1, TCH-2. The double speed test patterns for a pin-multiplex-mode are inputted from the tester channels TCH-3, TCH-4, for example, into the semiconductor integrated circuits DUT-1, DUT-2, respectively.

The flow chart shown in FIG. 4 represents the case of testing the output signals from the output terminals OUT1, OUT2 of the semiconductor integrated circuit DUT-1, DUT-2 simultaneously in a double speed mode. The output signal of the semiconductor integrated circuit DUT-1 is inputted into a terminal TE1 of the tester channel TCH-1. The output signal of the semiconductor integrated circuit DUT-2 is inputted into a terminal TE2 of the tester channel TCH-2 (Step S01).

Then, a level determination signal LS-1 of the tester channel TCH-1 is inputted into the tester channel TCH-2. A level determination signal LS-2 of the tester channel TCH-2 is inputted into the tester channel TCH-1 (Step S02).

Specifically, the level determination signal LS-1 of the tester channel TCH-1 is inputted into the AND gate 21-2 of the signal multiplexing unit 2-2 of the tester channel TCH-2. The level determination signal LS-2 of the tester channel TCH-2 is inputted into the AND gate 22-1 of the signal multiplexing unit 2-1 of the tester channel TCH-1.

A double speed mode designation signal to be inputted into the AND gates 21-1, 21-2 is set to ‘1’ so that a double speed test mode is designated (Step S03).

The strobe time of the tester channel TCH-1 is set in a first half of a test cycle by a designation signal STB-1, while the strobe time of the tester channel TCH-2 is set in a second half of the test cycle by a designation signal STB-2 (Step S04).

A designation signal of a pin-multiplex-mode is inputted into the tester channels TCH-3, TCH-4 after the above setting are completed. Double speed test patterns are inputted into input terminals IN1, IN2 of the semiconductor integrated circuit DUT-1, DUT-2 from the tester channel TCH-3, TCH-4, respectively. The input causes output of double speed output signals from output terminals OUT1, OUT2 of the semiconductor integrated circuit DUT-1, DUT-2, respectively.

Outputs T-1, T-2 of the signal multiplexing units 2-1, 2-2 obtained based on the above output signals are compared with expected values 3H, 3L in the expected value comparison units 3-1, 3-2, as mentioned above. The comparison results are outputted from the expected value comparison units 3-1, 3-2 (Step S05).

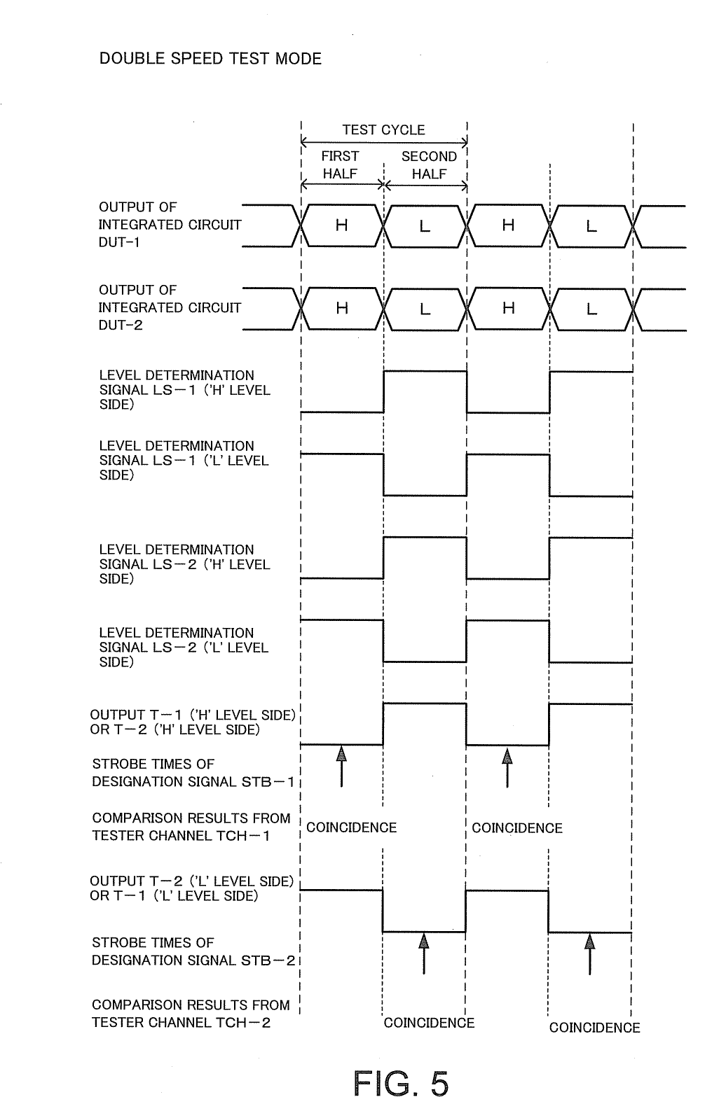

FIG. 5 shows signal waveforms of the respective units obtained when the semiconductor integrated circuits are tested according to the flow chart shown in FIG. 4.

The signal waveforms are produced when normal operations of the semiconductor integrated circuit DUT-1, DUT-2 are carried out under a double speed mode. In this case, the expected value 3H is used for the test of the first half of the test cycle, and the expected value 3L is used for the test of the second half period of the test cycle. The strobe times are set in the first halves of the test cycles for the tester channel TCH-1. The output T-1 of ‘H’ level side from the signal multiplexing unit 2-1 is compared with the expected value 3H in the tester channel TCH-1. The strobe times are set in the second halves of the test cycles for the tester channel TCH-2. The output T-2 of ‘L’ level side from the signal multiplexing unit 2-2 is compared with the expected value 3L in the tester channel TCH-2.

In this case, at each of the strobe times, a comparison result showing “coincidence” with the expected values is outputted from the expected value comparison units 3-1, 3-2. It means that the tester channels TCH-1, TCH-2 provide the comparison results between the expected values and the outputs T-1, T-2 based on the output signals obtained from the semiconductor integrated circuits DUT-1 and DUT-2 at double speed, simultaneously by one-time test.

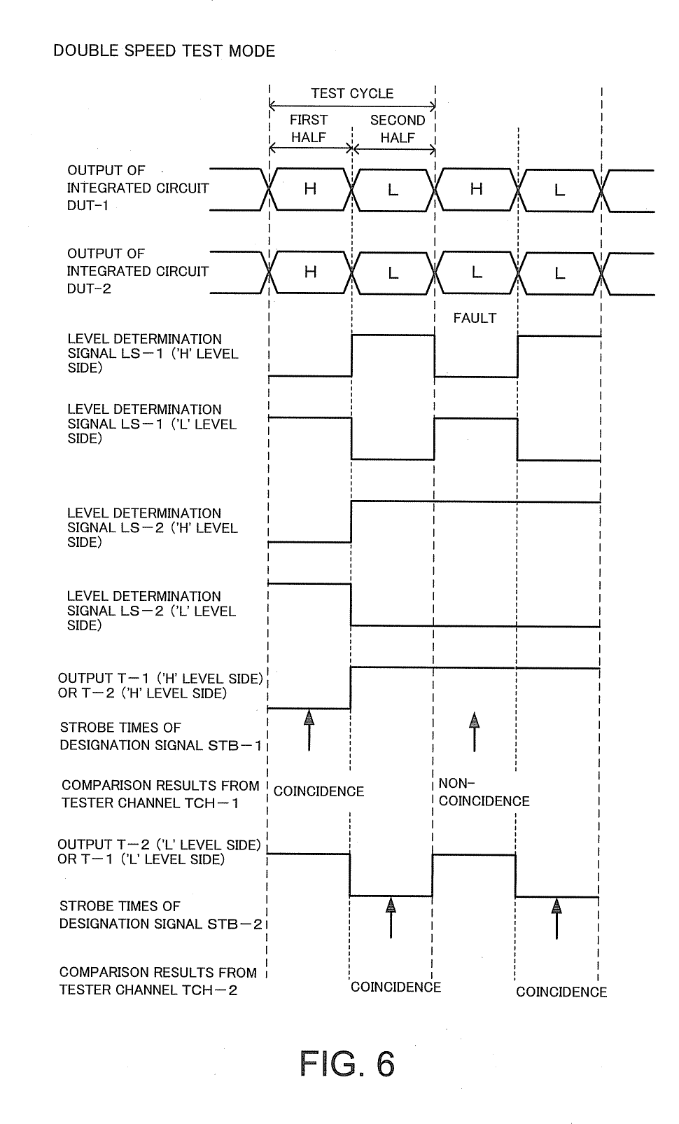

On the other hand, FIG. 6 shows signal waveforms of the respective units in the case where the semiconductor integrated circuit DUT-2 has an operational defect under a double speed mode.

The defect is that an ‘L’ level signal is outputted from the semiconductor integrated circuit DUT-2 in the period though an ‘H’ level signal should be outputted. In this case, the level determination signal LS-2 of ‘H’ level side and the level determination signal LS-2 of ‘L’ level side show abnormalities in the period of occurrence of the operational defect.

The abnormality of the level determination signal LS-2 of ‘H’ level side is taken into the signal multiplexing unit 2-1 of the tester channel TCH-1, and is reflected in the output T-1.

The strobe time of the tester channel TCH-1 is set to arise in the period of occurrence of the operational defect of the semiconductor integrated circuit DUT-2. Thus, the expected value comparison unit 3-1 outputs a comparison result showing “non-coincidence” with the expected value 3H, corresponding to the abnormality of the level determination signal LS-2 of ‘H’ level side reflected in the output T-1 of the signal multiplexing unit 2-1.

“Non-coincidence” with the expected value 3H or 3L may be detected in the tester channel TCH-1 or TCH-2, when the semiconductor integrated circuit DUT-1 or DUT-2 has an operational defect.

In this case, it cannot be identified which of the semiconductor integrated circuits DUT-1 and DUT-2 causes “non-coincidence”.

A method to identify the semiconductor integrated circuit causing “non-coincidence” when such “non-coincidence” is detected, will be explained below.

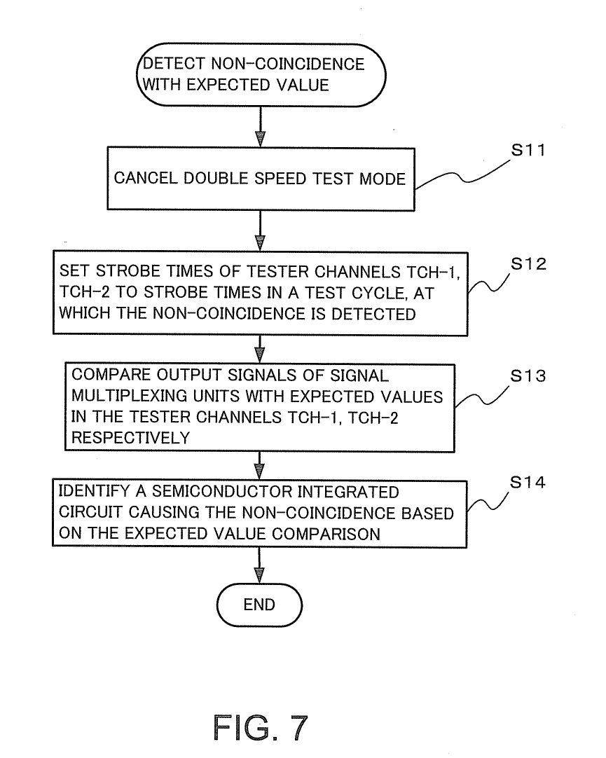

FIG. 7 shows a test flow to be performed to identify the semiconductor integrated circuit causing “non-coincidence” when “non-coincidence” with the expected value is detected in either of the tester channels under a double speed test mode.

When “non-coincidence” with the expected value is detected in either of the tester channels in the test flow shown in FIG. 4, the double speed mode designation signal is set to ‘0’, and the double speed test mode is canceled (Step S11).

Then, the designation signals STB-1, STB2 of the tester channels TCH-1, TCH-2 are set to indicate a strobe time in a test cycle at which “non-coincidence” with the expected value arises in the test flow of FIG. 4. Expected value comparison is stopped in the test cycles other than those in which the “non-coincidence” arises (Step S12).

Since the “non-coincidence” is detected at the strobe time set in the first half of the test cycle in the case shown in FIG. 6, the designation signals STB-1, STB2 are set in the first half of the test cycle.

Then, when double speed test patterns of the pin-multiplex-mode are inputted into the semiconductor integrated circuits DUT-1, DUT-2 by the tester channels TCH-3, TCH-4, output signals of the double speed are outputted from the semiconductor integrated circuits DUT-1, DUT-2 in response to the input.

Expected value comparison is performed in the tester channels TCH-1, TCH-2 with respect to the output signals from the semiconductor integrated circuits, and the comparison results are outputted (Step S13).

In the test flow, the level determination signals LS-1, LS-2 are outputted to the expected value comparison units 3-1, 3-2 as they are, since the double speed test mode is canceled as described above.

Thus, expected value comparison with the output signal of the semiconductor integrated circuit DUT-1 is performed in the expected value comparison unit 3-1 of the tester channel TCH-1. Expected value comparison with the output signal of the semiconductor integrated circuit DUT-2 is performed in the expected value comparison unit 3-2 of the tester channel TCH-2.

The semiconductor integrated circuit, whose output does not coincide with the expected value 3H or 3L, is identified based on the comparison results of the tester channels TCH-1, TCH-2 (Step S14).

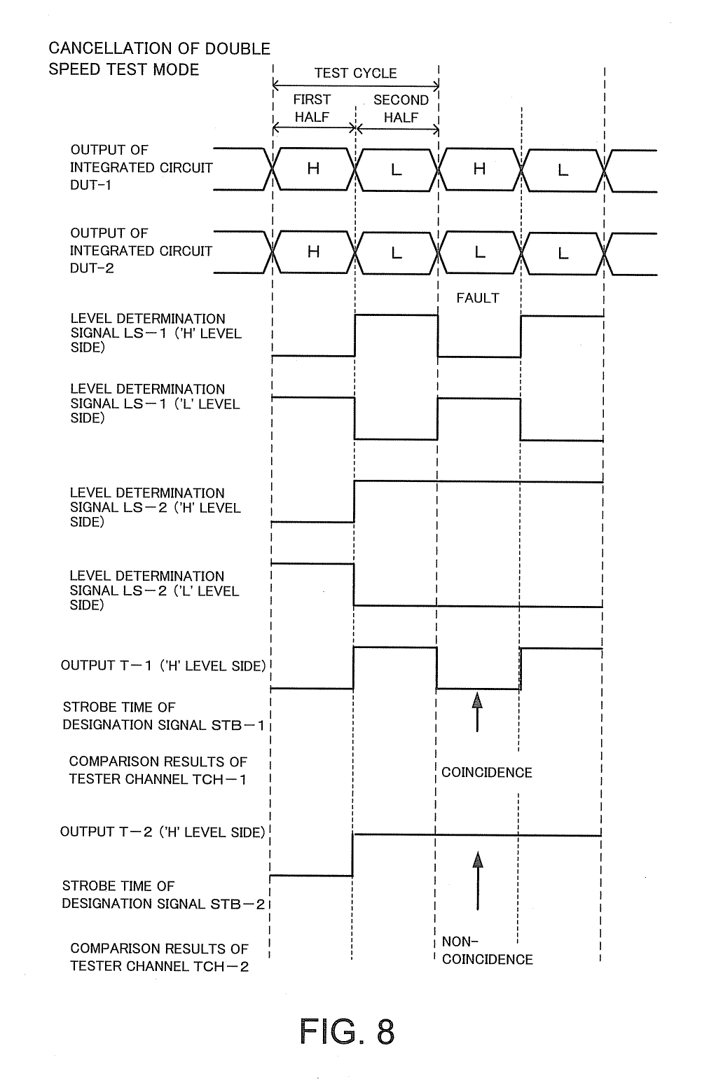

FIG. 8 shows wave forms of an operation example of a test which is performed by the flow shown in FIG. 7.

In the case shown in FIG. 8, an output T-1 of ‘H’ level side from the signal multiplexing unit 2-1 and an output T-2 of ‘H’ level side from the signal multiplexing unit 2-2 are compared with the expected value 3H respectively at the strobe time set in a first half of a test cycle under cancellation of a double speed mode,

Consequently, a comparison result of “non-coincidence” with the expected value 3H or 3L is detected in the tester channel TCH-2. By this detection, the semiconductor integrated circuit DUT-2 is identified as that causing the “non-coincidence”

According to the embodiment, double speed test can be performed to test output signals from a plurality of semiconductor integrated circuits simultaneously using two tester channels. The output signals from the semiconductor integrated circuits can be simultaneously verified at a double speed without decreasing the number of usable tester channels substantially.

Furthermore, the embodiment can identify which of the semiconductor integrated circuits is defective when one of the circuits causes an operational defect.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

What is claimed is:

1. An apparatus for testing a semiconductor integrated circuit, comprising plural tester channels, each of the tester channels being capable of outputting a double speed test pattern when a pin-multiplex-mode is designated, and being provided with:
a level determination unit configured to determine whether an inputted signal level fulfills a predetermined value and to output a level determination signal;
a signal multiplexing unit configured to multiplex the outputted level determination signal and a level determination signal obtained from a level determination unit of another one of the tester channels when a double speed test mode is designated, the signal multiplexing unit further outputting a signal corresponding to the level determination signal outputted from the level determination unit of each of the tester channels when the double speed test mode is canceled; and
an expected value comparison unit configured to compare the output of the signal multiplexing unit with an expected value and to output a comparison result,
wherein a strobe time can be set individually for each of the tester channels to obtain the comparison result.

2. An apparatus according to claim 1, wherein the designation and cancellation of the double speed test mode can be controlled independently from output of the double speed test pattern.

3. An apparatus according to claim 1, wherein each of the tester channels has a pattern generator and a double speed test pattern generation unit to receive a signal for designating a pin-multiplex-mode.

4. An apparatus according to claim 3, wherein each of the tester channels further includes a terminal to connect with a semiconductor integrated circuit to be tested, wherein the terminal is connected to the double speed test pattern generation unit via a buffer.

5. An apparatus according to claim 1, wherein each of the tester channels further includes a terminal to connect with a semiconductor integrated circuit to be tested, wherein the level determination unit is connected with the terminal via a buffer.

6. An apparatus according to claim 1, wherein the signal multiplexing unit includes an AND circuit and an OR circuit, the AND circuit receives the level determination signal outputted from the level determination unit of the other one of the tester channels and receives a signal to designate the double speed test mode, and the OR circuit receives an output from the AND circuit and receives the level determination signal obtained from the level determination unit of the each of the tester channels.

7. An apparatus according to claim 1, wherein the expected value comparison unit receives a designation signal to designate the strobe time.

8. An apparatus according to claim 1, wherein the level determination unit is capable of outputting a first signal compared with a predetermined high level value and is capable of outputting a second signal compared with a predetermined low level value, and the signal multiplexing unit is capable of outputting third and fourth signals based on the first and second signals respectively.

9. An apparatus for testing a semiconductor integrated circuit, comprising first and second tester channels, each of the first and the second tester channels being capable of outputting a double speed test pattern when a pin-multiplex-mode is designated, the first tester channel being provided with:
a first level determination unit;
a first signal multiplexing unit; and
a first expected value comparison unit,
the second tester channel being provided with:
a second level determination unit;
a second signal multiplexing unit; and
a second expected value comparison unit, wherein
the first and the second level determination unit are configured to determine whether an inputted signal level fulfills a predetermined value and to output first and second level determination signals, respectively,
the first and the second multiplexing unit are configured to multiplex the outputted first and second level determination signals and the second and first level determination signals obtained from the second and the first level determination units respectively when a double speed test mode is designated, and to output signals corresponding to the first and second level determination signals outputted from the first and second level determination units respectively when the double speed test mode is canceled, and
the first and the second expected value comparison units are configured to compare the outputs of the first and the second signal multiplexing units with expected values and to output comparison results respectively, and wherein
different strobe times can be set for the respective first and second tester channels to obtain the comparison results.

10. An apparatus according to claim 9, wherein the designation and cancellation of the double speed test mode can be controlled independently from output of the double speed test pattern.

11. An apparatus according to claim 9, wherein each of the first and the second tester channels has a pattern generator and a double speed test pattern generation unit to receive a signal for designating a pin-multiplex-mode.

12. An apparatus according to claim 11, wherein each of the first and the second tester channels further includes a terminal to connect with a semiconductor integrated circuit to be tested, wherein the terminal is connected to the double speed test pattern generation unit via a buffer.

13. An apparatus according to claim 9, wherein each of the first and the second tester channels further includes a terminal to connect with a semiconductor integrated circuit to be tested, wherein each of the first and the second level determination units is connected with the terminal via a buffer.

14. An apparatus according to claim 9, wherein each of the first and the second signal multiplexing unit includes an AND circuit and an OR circuit, the AND circuit receives the second level determination signal outputted from the second level determination unit and receives a signal to designate the double speed test mode, and the OR circuit receives an output from the AND circuit and receives the first level determination signal obtained from the first level determination unit.

15. An apparatus according to claim 9, wherein each of the first and the second expected value comparison units receives a designation signal to designate each of the strobe times.

16. An apparatus according to claim 9, wherein each of the first and the second level determination units is capable of outputting a first signal compared with a predetermined high level value and is capable of outputting a second signal compared with a predetermined low level value, and each of the first and the second signal multiplexing units is capable of outputting third and fourth signals based on the first and second signals respectively.

17. A method for testing a semiconductor integrated circuit in accordance with designation of a pin-multiplex-mode, comprising:
inputting double speed test patterns into first and second semiconductor integrated circuits to be tested respectively;
inputting first and second output signals outputted from the first and second semiconductor integrated circuits into first and second tester channels respectively;
determining signal levels of the first and second output signals in the first and second tester channels, and inputting first and second level determination results into the second and first tester channels;
designating a double speed test mode for the first and second tester channels;
setting a strobe time of the first tester channel in a first half of a test cycle, and setting a strobe time of the second tester channel in a second half of the test cycle; and
comparing signals corresponding to the first and second level determination results with expected values by the first and second tester channels respectively.

18. A method according to claim 17, further comprising, when the comparison detects a difference between the first or the second level determination results and either of the expected values:
canceling the double speed test mode;
setting the strobe times of the first and second tester channels to the time at which the difference is detected;
performing expected value comparison in the first and the second tester channels; and
identifying the first or the second semiconductor integrated circuit which causes the difference based on the results of the expected value comparison.
